(19) United States
(12) Patent Application Publication
(10) Pub. No.: US 2003/0234461 A1
(43) Pub. Date: Dec. 25, 2003

(54) Process of coloring concrete with a dosing system similar to a syringe for liquid colors

(76) Inventors: Daniel Fortin, Rock Forest (CA); Axel E. Jungk, Mainz (DE)

Correspondence Address: BLANK ROME LLP, THE FARRAGUT BUILDING, SUITE 1000, 900 17th STREET, NW, WASHINGTON, DC, 20006, US

(21) Appl. No.: 10/464,507

(22) Filed: Jun. 19, 2003

(30) Foreign Application Priority Data
Jun. 19, 2002 (CA) 2,389,885

(51) Int. Cl. B28B 1/00

(52) U.S. Cl. 264/40.4; 264/333

(57) ABSTRACT

The present invention focuses on a significant improvement of the processes to color concrete. Said objective is reached by a process to color concrete wherein one or more liquid and/or viscous colors are dosed with a dosing system similar to a syringe directly, either into the concrete mixer, or into the sand and/or the aggregates used to manufacture the batch of colored concrete, whereby said sand and/or aggregates are transported into the concrete mixer. The dosing system similar to a syringe is an apparatus that may receive, in a quantified manner; one or more liquid colors and is able to inject said colors quantitatively into the concrete mixer. The concrete is thus dyed, by the colors that it contains, by mixing and dispersing the colors in the concrete components.

### BACKGROUND OF THE INVENTION

1. Background of the Invention

The present invention focuses on a significant improvement of the processes to color concrete. Said objective is reached by a process to color concrete wherein one or more liquid and/or viscous colors are dosed with a dosing system similar to a syringe directly, either into the concrete mixer, or into the sand and/or the aggregates used to manufacture the batch of colored concrete, whereby said sand and/or aggregates are transported into the concrete mixer. The dosing system similar to a syringe is an apparatus that may receive, in a quantified manner; one or more liquid colors and is able to inject said colors quantitatively into the concrete mixer. The concrete is thus dyed, by the colors that it contains, according to the known art by mixing and dispersing the concrete components.

2. Description of Prior Art

Concrete is a construction material that has shown proven performance as decorative concrete that also satisfies aesthetic requirements. The coloring of the concrete mass, when manufacturing decorative concrete, conveys to it a long lasting coloring without a need for maintenance for several years.

Painted concrete surfaces, on the contrary, need to be repainted at short intervals. In fact, colored concrete has become very common, whether in facades, plates, pavers, tiles, anti-noise embankments, retaining walls, dikes, bridges and similar constructions, and also in form of colored mortar and of roughcast, also used for decorating facades.

Concrete is colored with the help of mainly inorganic pigments and, since recently, also with organic pigments. Examples are Manganese Oxide, Iron Oxide, Chrome Oxide and Carbon, that all have a proven record as concrete pigments. Especially Carbon and Iron Oxide pigments have shown to be very suitable.

Manufacturing of colored concrete however raises a number of problems. In the beginning the pigments are used in form of powders. Pigment powders develop pigment dust; and its use colors and dirties the people working with it, the machines, and the work places. Use of powder creates unacceptable working conditions.

In addition, these fine pigment powders agglomerates under the impact of humidity and builds up small lumps that could only be dispersed with great difficulty in the concrete mix. As a consequence one often observes a loss in tinting strength. In addition, pigment nests consisting of non-dispersed pigment, could be found at the surface of concrete products, colored with these powders. To overcome these problems the pigment powders demands regrinding and/or a longer dispersion and mixing time in the concrete mixer.

Because of the fine grind of the pigment powder particles, these powders, when stocked in silos, quickly loose their fluidity. They can only be transported out of the silos with great difficulty with high cost in manpower and machinery.

For the same reasons the dosing of these pigment powders with screw conveyors or vibrators demands considerable investment. In the present state of the art efforts have been made to solve the problems associated with the use of powder pigments, problems like bad working hygiene, the appearance of pigment dust during stocking in the silos and when dosing these powders automatically and the difficult dispersion of the pigment powders when used for coloring concrete.

Pigments are used in form of their aqueous dispersions. These kinds of pigment pastes usually contain 30-70% water as the transport medium, surfactant products and organic and/or inorganic pigments. In general, the pigments in these pastes have been well dispersed to reduce the dispersion time in the concrete mixer and to gain a maximum tinting strength.

However, despite the advantages realized when using the often pre-dispersed pigment pastes, their usage brings about other important disadvantages.

Sometimes, during storage, the liquid colors become viscous. Once metered into a dosing cylinder according to the state of the art, these colors no longer empty out of said cylinder in the required time frame neither by gravity nor with the help of a pump. In this case, this batch of liquid color is either returned to its supplier for reliquification or is diluted with water to reduce its viscosity. However, the addition of more water in general is not desirable, because often the aggregates and the sand already have sufficient water by themselves.

Today's state of the art dosing cylinders receive the liquid colors already in a quantified way, i.e. measured via gravity or via volume. In order to bring the liquid color into the concrete the emptying process out of the cylinder is supported by a pump and/or compressed air so to transport the color through the emptying hose attached to the metering cylinder. After the color has been emptied into the concrete there remain variable and significant quantities of color that stick in the cylinder, the pumps and the hoses. As a consequence the different concrete batches are not colored evenly, or the cylinder, the pump and the hose have to be washed with a certain amount of water to transport all metered color into the concrete. Another reason for the adding of water is to reduce the viscosity of the liquid colors so they flow freely out of the dosing cylinder.

However, concrete only supports a certain limited amount of water to solidify and be put into a form according to the technical rules. In general, for a dry concrete, the water/cement ration should not be any greater than 0.45, and preferably between 30-38%. Moreover sand and aggregates often already contain enough water to bring the water content of the concrete close to the acceptable limits.

In the systems for liquid colors known in the art, a change of color in a dosing cylinder is also difficult due to the requirement for cleaning these with water. That is why many of these systems comprise several dosing cylinders, each one used just for one color, to save on cleaning water that would be unacceptable in the concrete recipe.

This is why many producers of colored concrete have abandoned using aqueous liquid colors, because too often the inherent moisture present in sand and aggregates rejects the use of rinsing and cleaning water in the color system for liquids. On the other hand, water is required to color uniformly and regularly.

For this reason, the use of liquid colors for coloring concrete was considerably reduced and replaced by the use of dry pigment granules together with automatic metering systems, whereby both, granules and dosing system were significantly higher in cost than the powders or liquids systems.

The coloring of concrete with pigment granules today is state of the art.

In most cases, these granules are manufactured by producing first the liquid color, which is a pumpable aqueous suspension of the powder pigments. In an additional and expensive second manufacturing step, said liquids are atomized into little droplets and then dried formed into micro granules.

Even though, during the suspension process, i.e. the manufacturing of the liquid color, these pigments may be perfectly dispersed to yield their maximum tinting strength, the degree of pigment dispersion diminishes during drying, which makes these granules more difficult to disperse in concrete than their liquid counterparts.

In addition, as compared to the liquid colors, granulation involves significant cost for atomization and drying, mainly energy cost, labor and important investment cost for the spray towers.

The simulated granules obtained by agglomeration and/or compaction have not reached great popularity due to their high dust level, their extreme sensitivity against moisture and their difficulties during pneumatic transport in the current granules dosing systems.

The actually used granules are described in the European Patent No. EP-A-0 268 645, and in its U.S. equivalent U.S. Pat. No 4,946,505 and Canadian Patent No. 1,291, 849. These describe the coloring of concrete with pigment granules that must comprise one or more binders promoting the dispersion of the pigments in concrete to partially compensate for the loss of tinting strength during granulation.

Since all these binders in the granules are easily soluble in water, the impact of atmospheric humidity remains critical. Particularly in the concrete plants, near the vapor chambers, the humidity dissolves the binders in the granules and provokes an important agglomeration of these granules. Subsequently, they form lumps or even pigment blocks, which are hard enough to adversely affect the functioning of the dosing and pneumatic transport systems when theses granules are stored and used.

According to German Patent No. DE 43 36 613-C1 and U.S. Pat. No. 5,484,481 (belonging to Bayer A G, Leverkusen, D E), it is possible to manufacture granules for the coloring of concrete by preparing a mixture of different inorganic pigments with at least one binder. The binders, in most cases, are already mentioned in U.S. Pat. No. 4,946,505, by forming a cohesive powder which under controlled application of pressure is compacted to yield thin plates, which thereafter are ground and granulated by agglomeration.

The disadvantages of said granules are their instability, and the formation of powder and dust. Granules according to this process do not always flow freely and are not suitable to be metered with the current simple dosing systems. Moreover, said granules, despite their complicated manufacturing process, do not display any advantage as compared to the granules according to U.S. Pat. No. 4,496,505.

The granules described in Canadian Patent No. CA 2,263, 667 have also found an important industrial application. This patent describes the production and use of granules for coloring concrete with granules that have been obtained by atomization and stabilized by resins that are insoluble in concrete. Even though these granules no longer are sensitive to humidity, their use requires efficient concrete mixers with a good milling and dispersing efficiency to fully develop the full tinting strength of the pigments used. Despite their advantages compared to the other mentioned granules, they bear the burden of granulation cost, energy and heavy investment.

### SUMMARY OF THE INVENTION

An analysis of the state of the art for coloring concrete, with powders, with liquid colors or with granules yields as a result that it is obvious and desirable to use the liquid colors for concrete coloring for the following reasons:

1) gain in tinting strength;

2) ease of dispersion;

3) more economical production cost as compared to granules; and

4) ease of automatic handling.

The inventors, therefore, have conceived a new concrete coloring system, new and innovative as compared to the other known systems.

The present invention, therefore, has conceived an improved simple and modem process for automatically coloring concrete, whereby the process uses a system for coloring concrete comprising liquid and potentially viscous colors and uses a dosing system similar to a syringe, system that eliminates the disadvantages found when using powder pigments, and or granules and/or liquid systems according to the state of the art.

This process avoids the requirement for addition of unwanted rinsing water into the concrete. At the same time, this process meters the liquid and/or viscous colors in their full quantity, i.e. quantitatively into the concrete, thus preserving the advantages of the liquid colors, i.e. their greater tinting strength, ease of dispersion, improved working hygiene at significantly lower production cost as compared to the granules. These colors can easily be manipulated by pumps and hoses in a simple dosing system similar to a syringe.

The first objective of this invention, therefore, provides a process for coloring concrete, during which, with the help of a dosing system similar to a syringe, liquid and/or viscous colors are metered directly into the concrete mixer, or into the sand and/or into the aggregates used to form said batch of colored concrete before their transport into the concrete mixer. The concrete is colored thereafter according to the state of the art by mixing and dispersing the concrete ingredients and the colors.

Another objective of this invention provides a dosing system similar to a syringe for coloring concrete whereby said dosing system comprises 1) a cylinder with an interior having a lower part and an upper part; 2)at least one opening to add a quantity of liquid color into the interior of the cylinder; 3) a means to quantitatively determine the color quantity added into the interior of said cylinder; 4) a mobile piston located in said cylinder; 5) a means to make the mobile piston move; and 6) an opening at the lower part of said cylinder allowing for an expulsion of the liquid color therein present, by movement of the mobile piston from the upper part to the lower part of said cylinder.

The word “concrete” as used herein designates the raw materials before their chemical reaction: cement and/or other hydraulic binders, and/or fly ashes, silicate, sand and/or the aggregates, water and other components, for the production of bondstones, sheets, tiles, pavers interlocking pavers, retaining walls and/or mortar. The word “concrete” stands also for cement-based mortars, fiber cement products and other articles originally using cement and/or hydraulic binders for their manufacture.

In the frame of the present invention the terms “liquid colors and/or viscous colors” designate aqueous pigment suspensions with or without surfactant(s) or resinous additive(s) and a solids content of more than 30% by weight with potential viscosities of more than 1000 cP. Even though these viscous liquid colors are known in the art , with a high pigment concentration and viscosities of more than 1000 cP, they are not used for coloring concrete, because there was no feasible dosing system and manipulation was difficult, in spite of the fact, that their use was desirable because of their low water content.

The term “pigments” designates inorganic and/or organic colorants, including white colorants, such as Titanium Dioxide, the various red, yellow, brown and black iron oxides, and their mixtures, Carbon Black, Chromeoxide, Manganese Oxides, Cobalt spinells and others like organic pigments, metallo-organic pigments, phthalocyanines, Benzidine Yellows and other organic pigments.

In a preferred use of the invention the liquid and/or viscous colors may contain admixtures for concrete as for instance enumerated in the Annual Book of ASTM (American Society for Testing and Materials) Standard Volume 04.02 (1998), Standard Specification for Chemical Admixtures for Concrete or admixtures that are named in the 6ₜₕ Metric Edition of the Canadian Portland Cement Association, chapter with the title “Dosage and Control of Concrete mixtures (1995)” chapter 7. They should be used in amounts required by the recipe for the batch of concrete to be manufactured. The system according to the invention may also serve to meter said admixtures, however, without special advantage for low viscosity liquid admixtures.

In the frame of the present invention the term “dosage system similar to a syringe” designates each and every apparatus that may be loaded in a quantified way with one or more liquid colors and is able to expulse the color quantitatively into a concrete mixer, before, during and/or after the other concrete ingredients are filled into the mixer and are mixed so to produce concrete. The liquid and or viscous colors may also be expulsed onto the sand and or the aggregates used to produce the batch of colored concrete before they are shed into the concrete mixer.

The dosing system similar to a syringe expulses said colors into the concrete quantitatively. The remainders of color that stick to the walls of the dosing system are insignificant in quantity, such that they do not visibly impact upon the coloring of the concrete even if there is a change in color, from black to yellow for instance.

This improvement of the concrete coloring process eliminates the disadvantages of the liquids dosing systems of the present state of the art, by abolishing the need to add water in significant quantities to empty and/or rinse the dosing system. That is why the dosing system similar to a syringe and the corresponding process for coloring concrete has become the best available process in the art.

The dosing system similar to a syringe therefore is used to quantitatively meter the colors into the concrete, such that the remainders of color that stick to the walls of the dosing system are insignificant in quantity, such that they do not visibly impact upon the coloring of the next concrete batch, even if there is a change in color. When there is a change in color, for instance from black to yellow, in most cases, said remaining color sticking to the walls of the dosing system is too little to have a noticeable impact upon the color of the concrete.

In a preferred way to execute the invention, the dosing cylinder similar to a syringe with enough volume to receive and hold the liquid and/or viscous colors, is suspended via one or more weighing cells above the concrete mixer. The incoming color can also be quantified via a volumetric device, by a level indicator or ultrasound. The cylinder comprises, preferably at its lower part so to limit superfluous contamination, enough valves to receive all the colors needed, for instance 6 valves for 6 colors. These valves open and close so to make the color flow into the dosing cylinder in the required quantity. The color is transported from the color holding tank by pumps, pipes and/or gravity into said cylinder, whereby the incoming color quantity is controlled via the weighing cell(s) or a volumetric device and the opening and closing of the valve respectively. Instead of a liquid color a liquid admixture for concrete can also be used.

With the help of several valves it is possible to add several colors, one after the other, into the cylinder, so to mix in a reproducible way a whole range of colors. The lower contains a valve that opens into the concrete mixer, onto the aggregates and/or the sand used for the concrete batch to be colored.

The upper part of the cylinder, similar to a syringe, holds a piston that closely rubs the walls of the cylinder like in a syringe plunger.

Once the desired quantities of color have been dosed into the cylinder and after a signal has been given by the batching control system of the concrete mixer, the valve in the lower part of the cylinder opens to permit the expulsion of the liquid and/or viscous color into the concrete mixer, the aggregates and/or the sand used for that batch of concrete to be colored.

The movement of the piston may be done in different ways, for instance by applying compressed air onto the dry part of the piston, by movement of the arm of a pneumatic or hydraulic cylinder from the outside of the piston.

Like in a syringe, the piston, with the help of an O-ring, cleans the wall of the dosing cylinder, by moving from top to bottom, of the color that was sticking. Once arrived at the bottom of the cylinder the piston has cleaned the interior wall of the cylinder of color and the liquid and/or viscous color has completely been expelled from the dosing cylinder to color the concrete. The only color that remains in the cylinder pertains to the outlet hose of the exit valve and in the entrance valves for the colors in the lower parts of the cylinder. These quantities are insignificant such that they do not visibly impact the coloring process in progress nor the following color, if there is a color change. In a very limited number of cases where even a very small amount of color residue may be undesirable, a minimal quantity of water, having no impact upon the concrete chemistry of the respective concrete batch, may be used for rinsing via a water valve at the lower part of the cylinder or via a valve that is already used for entering color and shed into the concrete mix in progress.

Once the color has been injected into the concrete, the piston moves upwards again and at the same time or a bit later the exit valve closes; thus, the cylinder is ready again for the next coloring cycle with the same liquid and/or viscous colors or other liquid and/or viscous colors.

Since the dosing system is closed, there is no danger for the liquid and/or viscous colors to dry out and block the dosing system. The liquid and/or viscous colors, as usual and known in the art, are stabilized against settling with the help of thixotropic agents; therefore, the coloring system may remain inactive for quite a longtime and can be put back to work without problems.

If unstabilized colors are used, the pipe that brings the colors to the dosing cylinder should lead back into the color storage tank to guarantee regular consistency of the liquid and/or viscous colors.

The process according to the invention has the following advantages:

1) the full tinting strength of the pre-dispersed liquid colors is available;

2) pigment dispersion time in concrete is minimized and it takes less concrete mixing time as compared to the use of powders and or granules; therefore concrete mixing is faster and therefore more productive;

3) rinsing water is eliminated and with it the disadvantages of the presently known liquid colors systems;

4) the very same cylinder may be used for different colors so to synthesize one's proprietary colors; and

5) the system is simple and very economical as compared to currently known dosing systems.

This improvement in the process for coloring concrete brings about advantages when compared to the powder and granules systems, because it eliminates the disadvantages of the current liquid systems, by removing the need to use significant amounts of additional water to decrease the viscosity of the viscous colors, for emptying and/or cleaning the dosing systems known in the art. It therefore presents the best available process.

The invention and the way it functions will be better understood when reading the description and following a preferred way of using the invention and some other versions. The description refers to the enclosed drawings.

### DETAILED DESCRIPTION OF THE DRAWINGS

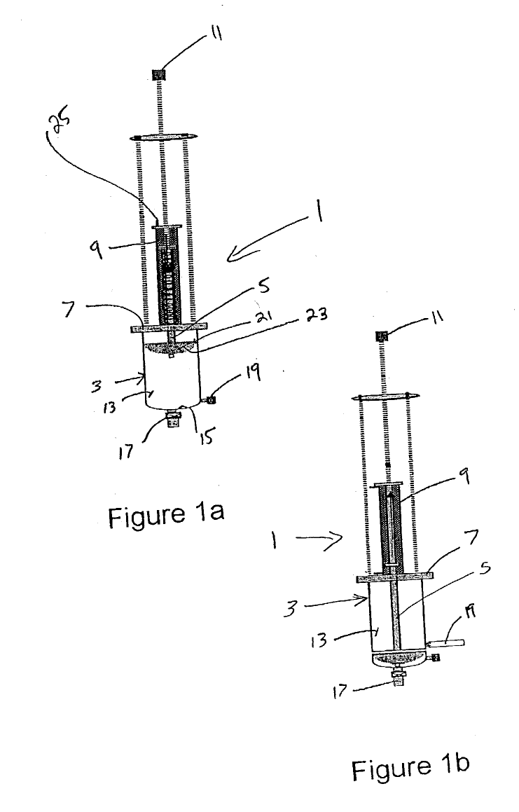

FIG. 1a shows a cross section of the dosing system similar to a syringe, showing the system with a lifted piston.

FIG. 1b is a cross section of the dosing system similar to a syringe showing the system with the piston in down position.

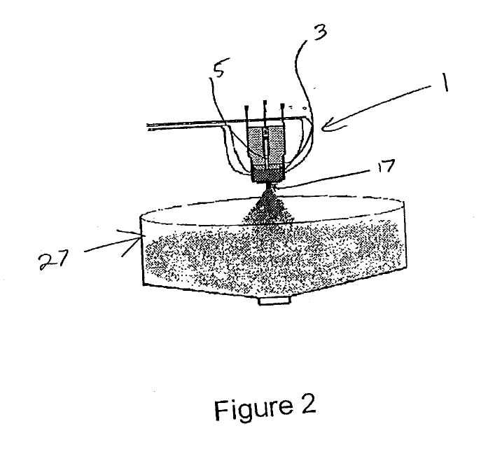

FIG. 2 is a perspective view of the dosing system similar to a syringe showing how the color is injected into a concrete mixer.

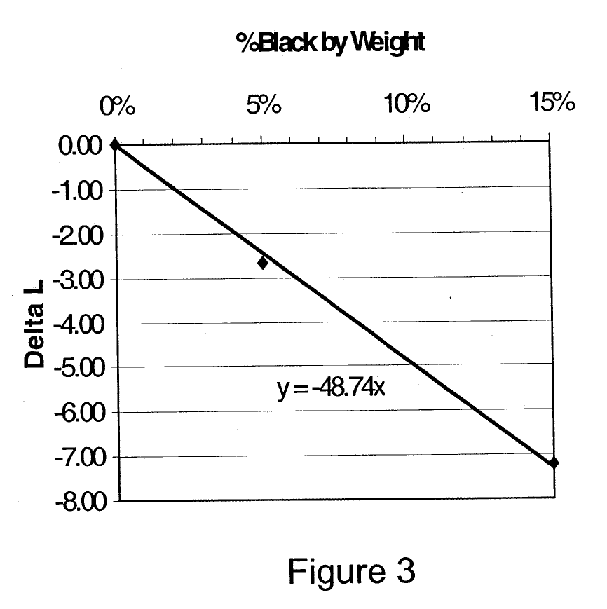

FIG. 3 shows a linear correlation between Delta L and contamination of black color.

### DETAILED DESCRIPTION OF PREFERRED REALIZATIONS OF THE DOSING SYSTEM SIMILAR TO A SYRINGE

Referring to FIGS. 1a and 1b, the dosing system according to the invention (1) comprises a cylinder (3) made out of metal or plastic. The cylinder (3) may be closed at its upper part (7); it contains a piston (5) in its interior, the piston being mounted onto a device (9) allowing to measure the volume of the required color quantity, preferably between 15-25 liters. The dosing system (1) is suspended via a hook (11) onto one or several weighing cells (not shown) protected against vibrations. The protection against vibrations can be done by tranquilizers, shock absorbers and/or similar equipment.

The mobile piston (5) in the interior of the cylinder (3) adheres to the cylinder interior walls (1) like the piston in a syringe. At the center of the lower part of the cylinder (15) is mounted an exit valve (17). This exit valve (17), by preference, activated by a signal from the concrete mixer control system, opens up for the color to be injected into the concrete mixer.

At the lower part of the cylinder (15), at its outside, is mounted one (or several) valve(s) as a color entry (19), so to allow the liquid and/or viscous colors to enter the cylinder .

Opening and closing of that color entrance valve (19) is controlled by a PLC and/or a computer, which opens the color entrance valve (19) and closes it again as soon as the weighing cell or another measuring device indicates that the required quantity of liquid and/or viscous color has entered the cylinder. With this control system one or more liquid and/or viscous colors can be metered into the same cylinder, so e.g. to synthesize special color shades starting with a limited number a of liquid and/or viscous base colors.

Whenever the concrete mixer or another mechanism requires the color to be added, the exit valve (17) situated in the lower part of the cylinder (15) opens up and at the same moment or slightly after the piston (5) starts moving down the cylinder (3) to its bottom. The action of the piston expulses the liquid and/or viscous color out of the cylinder (3) into the concrete mixer, the sand or the aggregates. The piston at the same time, cleans the cylinder walls (13) by rubbing and pushing the color sticking to the cylinder walls to the bottom of said cylinder with the help of an O-ring (21). The O-ring may be made from rubber, Teflon® or other equivalent material. The cylinder walls (13), thus, are wiped from top to bottom by the O-ring (21) or an equivalent piece of equipment to the exit valve (17) of the cylinder (3) to practically expulse the color completely from the cylinder (3). The liquid and/or viscous color present in the cylinder (3) is completely expulsed into the concrete mixer. Once the cylinder (3) is emptied, the piston (5) moves upwards, the exit valve (17) closes; and the cylinder (3) is ready for the next coloring cycle.

In another version of the invention upon closing of the exit valve (17) the piston (23) remains at the bottom of the cylinder (15). Together with the start of the next coloring cycle the color entrance valve (19) opens itself and at the same time the piston (5) starts moving upwards (7) with the help of a motor or equivalent (not shown). The vertical movement of the piston (5) creates a vacuum in the cylinder (3) and thus helps the liquid color to enter. This version is the preferred embodiment for highly viscous colors.

To maintain and clean the dosing system (1) it is possible to install a water access at the lower part of the cylinder (15). The color entrance valve (19) may also serve to make the water enter the cylinder (3) if installed as a 3-way valve. In a preferred version the color entrance valves (19) are mounted such that they empty by gravity into the cylinder (3), once they are opened.

The color entrance valve or valves (19) are connected to flexible hoses (not shown) in which the liquid and/or viscous color is transported. The hose is flexible to neutralize and minimize its impact upon the weighing process. It is advantageous that the flexible hose arrives from the upper part of the cylinder (7). This arrangement reduces the risk of pigment deposition and facilitates the emptying of the hose. The color transport into the dosing cylinder (3) may be effected with the help of a pump and/or gravity, potentially helped by the vacuum created by the piston (5) movement in the interior of the cylinder(3). It can be advantageous to use an air driven double membrane pump. With these pumps it is possible to control the filling of the cylinder(3) by merely opening and closing the color entrance valves (19). When the valve (19) closes the pump will stop pumping by action of the counter pressure since the system is closed. When the color entrance valve (19) opens again counter pressure will fade by the emptying of the color out of the hose into the cylinder (3) and the air driven double membrane pump starts working again. To reduce the impact of the pump pulses a tranquilizer can be installed in the color pipeline.

FIG. 2 shows the positioning of the dosing system (1) according to the present invention with respect to a concrete mixer (27). Moreover, the piston (5) action in the cylinder, when it moves downwards to the cylinder's lower part (15), can be appreciated by observing that the liquid and/or viscous color is expulsed through the exit valve(17).

In an other version of the invention the movement of the piston (5) from up to down in the cylinder (3) may be effected with the help of compressed air via air valves mounted on the cylinder (3) in the upper part and above the piston and in the lower part below the piston ; application of compressed air will move the piston (5) in the desired direction. The piston (5) may also be moved with the help of an electrical motor, via a screw above the cylinder that is connected to the piston (5) and a motor (not shown).

It is obvious that the invention can be used in numerous versions without leaving the frame as defined in its claims.

The following examples are to demonstrate the advantages of the invention in comparison to present art.

The examples were realized with a machine described in FIGS. 1a and 1b as follows:

The dosing cylinder is made out of stainless steel and has a usable volume of 251; it is suspended on a weighing cell. A mobile piston equipped with an O-ring made out of Teflon® in the interior of the dosing cylinder is driven by compressed air to expulse the liquid and/or viscous color. The movement of the piston to expulse the color out of the dosing cylinder or to suck the color into the dosing cylinder, is helped by a second pneumatic cylinder situated outside and on top of the dosing cylinder. The outlet valve has a diameter of approx. 2.5 cm. At the lower part of the dosing cylinder are mounted four color entrance valves, each with a diameter of approx. 1.3 cm, and a valve for water of approximately 0.9 cm in diameter.

The dosing system that corresponds to the present state of the art is represented by the very same dosing cylinder; however, the mobile piston stays in the upper part of the dosing cylinder and stays immobile during the examples.

### EXAMPLE 1

This example proves that the time to empty the dosing cylinder (and to inject the color into the concrete mixer) is significantly shorter when using the system according to the invention, i.e. using the mobile piston, than with a system according to the state of the art (keeping the piston immobilized).

The results in a continuous coloring cycle are as follows and summarized in Table 1:

Properties of the liquid color and test conditions are as follows:

Viscosity=550 cP

Solids content=66%

Density=1.9 g/ml

Grind=18 microns

The color was fed into the dosing cylinder with an average weight of 0.242 kg/second (14.52 kg/minute).

Time to empty more than 99% of the color out of the dosing cylinder according to the present invention (with the help of the piston): 8 seconds

Rinsing water: 0 g

Time to empty the dosing cylinder at a level of 97% without the help of piston: 30 seconds

Rinsing water: 2000 g

TABLE 1

| | Target | Weight | Weight expelled color |
|---|---|---|---|
| Test# | Weight (Kg) | expelled color (Kg) | without pistol use (Kg) |
| 1 | 10.00 | 9.99 | 9.70 |
| 2 | 10.00 | 10.10 | 10.00 |
| 3 | 10.00 | 10.00 | 9.87 |
| 4 | 10.00 | 9.99 | 9.77 |
| 5 | 10.00 | 10.00 | 9.87 |
| 6 | 10.00 | 10.00 | 9.90 |
| 7 | 10.00 | 10.00 | 10.10 |
| 8 | 10.00 | 10.02 | 9.85 |
| 9 | 10.00 | 10.00 | 9.88 |
| 10 | 10.00 | 9.98 | 10.15 |

### EXAMPLE 2

This example demonstrates the advantages of the coloring system according to the invention as compared to the state of the art by comparing the impact of the residual color in the dosing cylinder when changing color from black to yellow by using the mobile piston according to the invention and by leaving the mobile piston immobilized (state of the art)

Method: In order to show the advantages when using the dosing system according to the invention, i.e. the quasi quantitative expulsion of the color out of the dosing system, we have determined the degree of contamination of the next color during a color change by the foregoing residual color in the dosing cylinder by 1) using the system according to the invention, i.e. by using the mobile piston; and 2) using the system according the present art, i.e. by keeping the piston immobilized in the dosing cylinder during the emptying process. All this was accomplished by using only a small amount of new color

Two standard commercial liquid colors were used for the test.

The first one was an aqueous suspension of black iron oxide pigment with a viscosity of 2000 cP and a density of 1.8 g/ml.

The second one was an aqueous suspension of yellow iron oxide pigment with a viscosity of 375 cP and a density of 1.78 g/ml.

For the trials the above-described cylinder was used with a loading capacity of 251 (65 kg) using the mobile piston according to the invention and working without piston so to show the state of the present art.

10 kg of the black color were pumped into the cylinder and then emptied with and without piston. Thereafter different quantities of the yellow color were then pumped into the dosing cylinder and then emptied with and without use of the piston according to the quantities shown in Table 2. After being emptied out of the dosing cylinder a sample of the yellow color was collected to undergo color testing so to measure the impact of its contamination with the 10 kg of black color previously present in the dosing cylinder.

TABLE 2
Color quantities pumped into the dosing cylinder.

| | Weight of Black Color, | Weight of yellow color |
|---|---|---|
| Test | pumped and emptied (kg) | pumped and emptied) (kg) |
| 1-with piston | 10.0 | 10.0 |
| 2-with piston | 10.0 | 5.0 |
| 3-with piston | 10.0 | 2.0 |
| 4-without piston | 10.0 | 10.0 |
| 5-without piston | 10.0 | 5.0 |
| 6-without piston | 10.0 | 2.0 |

To determine the degree of contamination of the yellow color with the previously dosed black color a standard curve was developed showing different mixes of known small amounts of Black in the yellow color. A sample of dry yellow was mixed with known quantities of dry black pigment.

Subsequently these mixes were used to color Portland cement Type 10 according to a standard method of the industry using 5% by weight of pigment per cement. The dried colored cement paste then was measured with a spectrophotometer (“DATAFLASH 100” of the company “DATA COLOR INTERNATIONAL”).

The black content of the pigment mix in said cement samples was then related to the Delta L value of the spectrometer data as compared to the sample without black color, as shown in Table 3.

A linear function was assumed to relate the differences in darkness (Delta L) of the measured samples with a probable contamination with black color.

TABLE 3
Mixes of yellow and black compared to yellow

| Sample | % Black | Delta L |
|---|---|---|
| 1- | 0.0% | 0.00 |
| 2- | 5.0% | −2.68 |
| 3- | 15.0% | −7.23 |

FIG. 3 assumed a linear function (linear regression of 3 values) relating differences in Darkness (Delta L) with weight % of contamination of the yellow color.

Results:

As a last step in the test procedures a cement sample as described above was colored with 5% of a yellow pigment sample more or less contaminated with the black color of the previous dosing cycle and recovered as shown in Table one. Said colored cement samples were compared with a sample having been colored with an uncontaminated yellow color and the differences in darkness (Delta L) were measured and related, via Curve 1 to a degree of contamination with the black color

The results are in Table 4.

TABLE 4

| | | | | Calculated | |
|---|---|---|---|---|---|
| | | | Amount of | weight of | |
| | % | | yellow | contaminating | |
| | contamintaion | | contaminated | black color | calc. Volume. |
| Sample | with black | Delta L | (kg) | (Kg) | (ml) |
| 1-with piston | 1.90% | −0.83 | 1 | 0.1 | 107 |
| 2-with piston | 4.00% | −1.69 | 5 | 0.2 | 109 |
| 3-with piston | 6.00% | −2.50 | 2 | 0.12 | 6 |
| 4-without piston | 4.10% | −1.75 | 1 | 0.41 | 22 |
| 5-without piston | 4.80% | −2.10 | 5 | 0.2 | 135 |
| 6-without piston | 8.00% | −3.42 | 2 | 0.1 | 88 |

The example shows, that, using the system according to the invention, the maximum contamination is 0.2 kg of black color regardless of color input into the dosing cylinder. This residual color stays in the color entrance valves, the exit valve and the hose after the exit valve. Even when using greater amounts of color, the value for the residual color does not increase, because the O-ring of the mobile piston perfectly cleans the inner walls of the dosing cylinder. Naturally this does not occur when using the dosing cylinder according to the state of the art, keeping the piston immobilized in the upper part of the dosing cylinder.

It has been found, that when using 50 kg of black color, i.e. using the full capacity of the dosing cylinder, without use of the mobile piston the residual color will reach between 0.8-1 kg. In addition, since most dosing systems are tared and recalibrated before weighing the incoming colors, the residual colors accumulate color consumption and increase coloring cost.

For instance, when each recipe uses 350 kg cement to be colored with 5% pigment, each batch uses 17.5 kg of pigment, with a batch cycle lasting 5 minutes (12 batches per hour). In a 40 hour week at a pigment loss by contamination of 0.4 kg of pigment per batch approximately 200 kg of color are lost by contamination.

These examples clearly show the advantages of the dosing system according to the invention in comparison to the present art, namely

1) the speed of color expulsion;

2) the savings on rinsing water for obtaining an adequate cleanliness; and

3) its ease of color change.

Although certain presently preferred embodiments of the invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

What is claimed is:

1. A process for dyeing concrete comprising the steps of
providing of one or more liquid and/or viscous colors;
metering a predetermined amount of said one or more liquid and/or viscous colors into a concrete mixer and/or into aggregates and/or into sand, wherein said metering step is accomplished with a dosing system similar to a syringe; and
dispersing of said one or more liquid and/or viscous colors in the concrete.

2. A process according to claim 1, wherein the dosing system similar to a syringe comprises
a cylinder having an upper part and a lower part, said cylinder preferably being fixed right above the concrete mixer or at a place such, that the colors contained in said cylinder may be injected via the outlet valve into the concrete mixer and/or into the aggregates and/or into the sand;
a mobile piston in the cylinder's interior;
an outlet valve at the lower part of said cylinder;
one or more entrance valves for the liquid and/or viscous colors which are configured below said piston;
a means to move the piston;
a measuring system to quantify the amount of color entering said cylinder; and
a PLC and/or computer to control the process.

3. A process according to claims 1, wherein the measuring system to quantify the amount of color entering the cylinder consists of said cylinder being suspended by one or more weigh cells that are fixed above the concrete mixer or any other place such that the color or colors contained in said cylinder may be injected via a short distance through the outlet valve of said cylinder into the concrete mixer and/or into the aggregates and/or into the sand.

4. A process according to claims 1, whereby the measuring system to quantify the color that enters said cylinder works by volume.

5. Process according to claims 1, wherein the dosing system similar to a syringe is attached to the concrete mixer

6. Process according to claims 1, whereby said cylinder is filled with one or more liquid and/or viscous colors in a quantified way via the color entrance valves and whereby the liquid and or viscous color(s) are quasi completely expelled, out of said cylinder by said piston moving from top to bottom of said cylinder, into the concrete mixer and/or into the aggregates and/or into the sand, whereby the filling of said cylinder and the color expulsion are computer and/or PLC controlled

7. Process according to claim 6, whereby the liquid and/or viscous colors used have a viscosity higher than 700 cP.

8. Process according to claim 6, wherein the liquid and/or viscous colors comprise inorganic pigments, or organic pigments or mixtures of both

9. Process according to claim 6, where in addition to liquid and/or viscous colors other liquid concrete additives are used.
